(19) United States
(12) Patent Application Publication
(10) Pub. No.: US 2003/0085951 A1
(43) Pub. Date: May 8, 2003

(54) Inkjet printheads

(76) Inventors: Phil Keenan, Dublin (IE); Jaime S. Hardisty, Albany, OR (US)

Correspondence Address: LADAS & PARRY, Suite 2100, 5670 Wilshire Boulevard, Los Angeles, CA, 90036-5679, US

(21) Appl. No.: 10/230,967

(22) Filed: Aug. 29, 2002

(30) Foreign Application Priority Data
Sep. 28, 2001 (EP) 01650111.6

(51) Int. Cl. B41J 2/135

(52) U.S. Cl. 347/44; 347/47

(57) ABSTRACT

A method of fabricating a printhead for an inkjet printer involves generating ink supply slots (12) in a substrate (10) and depositing thin film circuitry and resistors (16) on a front surface (14) of the substrate, before covering this front surface (including the opening for the ink supply slots) with a conformal tape (28). The ink supply slots are then back-filled with a filler material (32) which hardens to generate a false surface (29a) coplanar with the front surface (14) of the substrate. This false surface allows a thin photoresist layer (34) to be spun across the front surface. The photoresist is selectively exposed to create structures defining both thermal ejection chambers bounding the resistors in a lateral direction and the upper surfaces of these chambers, including ink droplet ejection orifices, thereby obviating the need for a separate nozzle plate and reducing the thickness of the printhead. The method of the invention also substantially reduces the number of processing steps involved in creating a finished printhead.

### TECHNICAL FIELD

This invention relates to inkjet printheads and to methods of fabricating such printheads.

### BACKGROUND ART

Inkjet printers operate by ejecting small droplets of ink from individual orifices in an array of such orifices provided on a nozzle plate of a printhead. The printhead forms part of a print cartridge which can be moved relative to a sheet of paper and the timed ejection of droplets from particular orifices as the printhead and paper are relatively moved enables characters, images and other graphical material to be printed on the paper.

A typical conventional printhead is fabricated from a silicon substrate having thin film resistors and associated circuitry deposited on a front surface of the substrate. The resistors are arranged in an array relative to one or more ink supply slots in the substrate, and a barrier material is formed on the substrate around the resistors to isolate each resistor inside a thermal ejection chamber. The barrier material is shaped both to form the thermal ejection chambers, and to provide fluid communication between the chambers and the ink supply slot. In this way, the thermal ejection chambers are filled by capillary action with ink from the ink supply slot, which itself is supplied with ink from an ink reservoir in the print cartridge of which the printhead forms part.

The composite assembly described above is typically capped by a metallic nozzle plate having an array of drilled orifices which correspond to and overlie the ejection chambers. The printhead is thus sealed by the nozzle plate, with the only path for ink flow from the print cartridge being via the orifices in the nozzle plate.

The printhead operates under the control of printer control circuitry which is configured to energise individual resistors according to the desired pattern to be printed. When a resistor is energised it quickly heats up and superheats a small amount of the adjacent ink in the thermal ejection chamber. The superheated volume of ink expands due to explosive evaporation and this causes a droplet of ink above the expanding superheated ink to be ejected from the chamber via the associated orifice in the nozzle plate.

Many variations on this basic construction will be well known to the skilled person. For example, a number of arrays of orifices and chambers may be provided on a given printhead, each array being in communication with a different coloured ink reservoir. The configurations of the ink supply slots, printed circuitry, barrier material, and nozzle plate are open to many variations.

Nevertheless, printheads of this general type have a number of associated disadvantages, which this invention is intended to address.

The fabrication of the printhead can involve a large number of separate processing steps. For example, U.S. Pat. No. 5,658,471 to Murthy et al. (assigned to Lexmark International, Inc.) describes a fabrication method involving:

a) depositing a dielectric layer on the front surface of a silicon wafer and depositing a mask layer followed by a photoresist layer on the rear side of the wafer;

b) exposing a pattern on the photoresist layer and removing unexposed photoresist to reveal parts of the mask layer;

c) etching through the revealed portions of the exposed mask layer to reveal etching slots at the surface of the substrate;

d) removing the remaining photoresist from the rear surface;

e) exposing the mask layer at the rear surface of the wafer to anisotropic etching, which etches the substrate through the etched feed slots;

f) monitoring the anisotropic etch depth until only a portion of the substrate thickness above the etched feed slots remains (to provide structural support to the overlying dielectric layer above these parts of the substrate during processing of the front surface);

g) depositing and patterning conductive, resistive and insulating traces on the dielectric layer on the front surface, to form the thin layer thermal resistors and associated circuitry, with alignment of the circuitry and feed slots being achieved by shining white light at the rear surface so the positions of the partially etched feed slots is visible from the device side;

h) covering the front surface with protective or passivation layers;

i) completing the anisotropic etch through the substrate from the rear surface up to the interface with the dielectric layer; and

j) removing the dielectric material and protective material above the etched feed slots in the substrate by e.g. laser ablation.

These steps result in a substrate having ink supply slots and thin layer circuitry. Although U.S. Pat. No. 5,658,471 does not describe the subsequent steps to complete the printhead, these will conventionally involve laying down and shaping a barrier material to form the thermal ejection chambers around the heating resistors, and capping this structure with a precisely aligned nozzle plate, which must itself be separately machined. This long sequence of processing steps may result in a costly and time-consuming fabrication procedure.

The nozzle plate in itself is a further source of problems. Not only is it necessary to accurately machine the orifices in the metal foil, but it is also imperative that these orifices be accurately aligned with the thermal ejection chambers in the barrier layer. Because the foil used tends to be very thin it is intrinsically difficult to handle without being damaged.

Furthermore, as ink is ejected through the nozzle plate, the volume of ink which is accelerated out through the orifice will tend not to move at a uniform speed. Any liquid flowing through a tube has a distribution of velocities through its volume. Ink at the interface with the surface of the tube is subjected to frictional drag and is retarded relative to the ink in the centre of the tube. This means that the droplet emerging from the orifice is not a uniformly moving volume as one would wish, but rather is a moving volume in which the different regions have a distribution of velocities. Such a volume of moving liquid is unstable and tends to break up, with “satellite droplets” breaking from the main body of the drop. This effect becomes more pronounced as the velocity of the emerging droplet is increased to provide faster operating frequencies and printing speeds.

Since each part of the volume ejected has the same velocity component parallel to the paper surface (due to the movement of the print cartridge) and a potentially different velocity component towards the paper (because satellite droplets will move slower or faster than the main droplet body), these satellite droplets will strike the paper in different locations to the main droplet body, leading to a loss of resolution. The thicker the nozzle plate, the more pronounced this effect will become. While it might appear that the solution is to make the nozzle plate as thin as possible, this makes the metallic foil of the plate more difficult to handle and apply to the printhead.

EP-A-1 078 754 discloses a fully integrated thermal inkjet printhead which omits the nozzle plate by forming the nozzles integrally with the ink ejection chambers using photoimaging techniques.

In this technique, after the thin film ink ejection elements and associated circuitry have been laid down on the substrate, and before the creation of the ink supply slots, a barrier layer of photoresist epoxy, such as SU-8, is spun across the top surface of the substrate wafer, i.e. over the thin film elements.

The ink supply slots are then formed from the back surface of the wafer using wet etching with tetramethyl ammonium hydroxide. The etch is controlled as it progresses through the wafer thickness, and is stopped when the slot reaches the front face and has a suitable width. The photoresist barrier layer is then used to create the three dimensional structures of the ink ejection chambers and of the ink ejection nozzles overlying the chambers. These structures are created by selectively irradiating regions of the photoresist to crosslink particular portions of the photoresist polymer, while leaving other regions without crosslinking. The unexposed polymer can then be washed away to reveal the structures formed of crosslinked polymer.

The wet etch used in this process forms an angled trench, i.e. a trench with sloping sidewalls which narrows from the back side of the wafer towards the front side of the wafer. (This narrowing is due to the fact that the etchant does not etch in a single direction, but etches the sidewalls outwards as well as etching into the crystal towards the front face; since the etchant starts at the back face the sidewalls are etched outwards more in the region of the back face due to the longer time spent in contact with the etchant.)

Wet etches such as are used in EP-A-1 078 754 are highly controllable and it is therefore possible to stop the etch when it reaches the front face of the wafer and the ink supply slot is completed. However, the process is very slow (typically lasting e.g. 10 hours) and requires careful monitoring. However, since the photoresist barrier layer above the ink supply slot must be used to create the structure of the ink ejection chambers and the ejection nozzles, it is impossible to use a less discriminatory and faster method of creating the ink supply slots since such techniques (for example laser drilling and sandblasting) will destroy the overlying photoresist layer in which the structures are formed.

Conversely, the ink supply slots cannot be formed by e.g. laser drilling before the photoresist layer has been spun on, because the gaps in the wafer surface due to the ink supply slots may be many times greater than the photoresist thickness, which prevents the photoresist layer from being spun on. It is therefore necessary, in the method of EP-A-1 078 754 to create the ink slots after the photoresist layer has been formed, and to also create them in a manner which does not compromise the photoresist layer. The slowness of this process is a severe disadvantage to the implementation of fully integrated thermal inkjet printheads which do not require nozzle plates.

### DISCLOSURE OF THE INVENTION

The invention provides a method of fabricating an inkjet printhead comprising the steps of:

a) providing a substrate having opposed front and rear surfaces and at least one ink supply slot which extends completely through the substrate between the front and rear surfaces;

b) at least partially filling the ink supply slot with a filler material which terminates at a false surface in the ink slot substantially coplanar with the front surface of the substrate;

c) covering the front surface and the false surface with a layer of resist material ;

d) exposing a pattern in the resist material to enable the selective removal of a portion of the resist material;

e) removing said portion of the resist material and thereby revealing a three-dimensional structure in the resist material; and

f) removing said filler material from said ink supply slot.

In the method according to a preferred embodiment of the invention, the number of process steps is significantly reduced by providing the substrate with ink supply slots, and then effectively regenerating the front surface allowing a resist layer to be spun on and exposed to varying degrees of depth, and in this way, creating orifices integrally in the photoresist layer.

By stating that the false surface in the ink slot is “substantially coplanar” with the front surface of the substrate, we mean that the discontinuity between the false surface and the front surface is sufficiently small that it does not interfere with the deposition of the resist material or the creation of the structures within the resist material to any appreciable extent. Preferably, the discontinuities are as small as possible.

In prior art processes, it is impossible to spin a thin photoresist layer onto regions of a wafer in which the ink supply slots are already formed, since the thickness of the photoresist layer (e.g. 5-20 microns) relative to the width of the ink supply slots (e.g. 100-200 microns) would not permit a layer of photoresist to be evenly deposited around the boundaries of the slots. The use of a false surface enables this to occur.

Preferably, the structure includes a plurality of ink ejection chambers and a plurality of orifices leading from said ink ejection chambers.

The method of the preferred embodiment of the invention leads to the further advantage that the nozzle plate can be dispensed with, overcoming the problems inherently associated with the nozzle plate.

A by-product of forming the orifices integrally in the photoresist layer is that the resolution and accuracy of the orifices is greatly increased relative to machined orifices in a metal foil. Furthermore, one can generate non-circular (e.g. triangular or elliptical) orifices without difficulty using photo-imaging techniques; in a machined nozzle plate, this can only be done with significant difficulty and increase in cost relative to providing a laser drilled circular-hole. Such non-circular orifices can be desirable for increased resolution due to the ability to shape the droplet as it emerges. Examples of suitable shapes and dimensions of non-circular orifices can be found in U.S. Pat. No. 6,123,413, the disclosure of which is incorporated herein by reference.

Further, preferably, step (a) comprises the sub-steps of:

i) providing a substrate having opposed front and rear surfaces;

ii) forming a plurality of resistors and conductive traces on the front surface of the substrate; and

iii) creating an ink supply slot which extends completely through the substrate between the front and rear surfaces.

In an alternative method according to the invention, step (a) comprises:

i) providing a substrate having opposed front and rear surfaces;

ii) forming a plurality of piezoelectric ink ejection elements and conductive traces on the front surface of the substrate; and

iii) creating an ink supply slot which extends completely through the substrate between the front and rear surfaces.

Thus, the inkjet printhead may be a thermal printhead or a piezoelectric printhead, for example.

Preferably, the step of partially filling the ink supply slot comprises applying a conformal laminate to the front surface of the substrate, filling the filler material into the ink supply slot from the rear surface, and removing the conformal laminate, whereby the interface with the conformal laminate provides the false surface.

The conformal laminate effectively provides a negative of the original front surface before the ink supply slots were created, since it stretches across the open surface of the supply slots. This provides a boundary against which the filler material can form the false surface.

The conformal laminate may be applied by heating said laminate and applying said laminate to the front surface with a roller.

The filler material is preferably a flowable material which solidifies under predetermined conditions, such as a low-melting point solid. In preferred embodiments, the filler material is selected from a wax and a photoresist.

The resist material may be selected from a photoresist and an ion-imageable resist. Such photoresist materials are of course well known in the art.

Preferably, the step of exposing the photoresist comprises subjecting the resist material in stages to different intensities and/or durations of exposure using different exposure patterns. Thus, one can use a first exposure step to expose a first area of resist material through the entire depth of the resist material layer, and a second exposure step to expose a second area of resist material only partially into the depth of the resist material layer.

In a most preferred embodiment, the first exposure is used to define lateral boundaries of thermal ejection chambers and the second exposure is used to define the upper surface of the thermal ejection chambers and the boundaries of orifices leading from the chambers.

The resist may be either positive or negative, with chemical development being used to wash away either exposed or unexposed resist material. Preferably, the development step is further effective to remove the filler material (step (f)).

The invention also provides an inkjet printhead comprising a substrate having opposed substantially parallel front and rear surfaces, at least one ink supply slot defined by substantially parallel sidewalls extending through said substrate between said front and rear surfaces, a plurality of ink ejection elements arrayed on the front surface of the substrate adjacent said ink supply slot, and a resist material layer covering said front surface and said ink ejection elements, wherein said resist material layer defines ink ejection chambers associated with said ink ejection elements, an ink supply path from said ink supply slot to said ink ejection elements, and integral ink ejection orifices associated with and leading from said thermal ejection chambers out of an exposed front surface of said resist material layer.

In a further aspect the invention provides a method of manufacturing a print cartridge comprising the steps of:

a)providing a cartridge body having at least one ink reservoir and at least one aperture for supplying ink from the reservoir to a printhead;

b)fabricating a printhead according to the method of the invention; and

c)assembling the printhead on the cartridge body with the at least one aperture in fluid communication with the at least one ink supply slot in the printhead.

The invention also provides a print cartridge comprising:

a)a cartridge body having at least one ink reservoir and at least one aperture for supplying ink from the reservoir to a printhead; and

b)a printhead according the invention provided on the cartridge body with the at least one aperture in fluid communication with the at least one ink supply slot in the printhead.

As used herein, the terms “inkjet”, “ink supply slot” and related terms are not to be construed as limiting the invention to devices in which the liquid to be ejected is an ink. The terminology is shorthand for this general technology for printing liquids on surfaces by thermal ejection from a printhead, and while the primary intended application is the printing of ink, the invention will also be applicable to printheads which deposit other liquids in like manner.

Furthermore, the method steps as set out herein need not necessarily be carried out in the order set out, unless implied by necessity. Thus, for example, it is equally possible that the thin film resistors or other ink ejection elements could be deposited after the ink supply slot has been created in the substrate. As a further example, it is not intended that the first and second exposures referred to above must be carried out in the order given, since the lower intensity exposure could be followed by the higher intensity exposure.

### BRIEF DESCRIPTION OF THE DRAWINGS

FIG. 1 is a plan view of a silicon substrate for use in a printhead according to a preferred embodiment of the invention having resistors and associated circuitry deposited thereon;

FIG. 2 is a partial enlarged sectional elevation through the substrate of FIG. 1, taken along the line II-II;

FIG. 3 is a perspective view of a complete wafer according to a preferred embodiment of the invention; and

FIG. 4 is a perspective view similar to that of FIG. 3, showing a conformal tape being applied to the wafer; and

FIGS. 5a-5g are sectional elevation views similar to that of FIG. 2, showing the same section of substrate as it undergoes further processing steps according to a preferred embodiment of the invention;

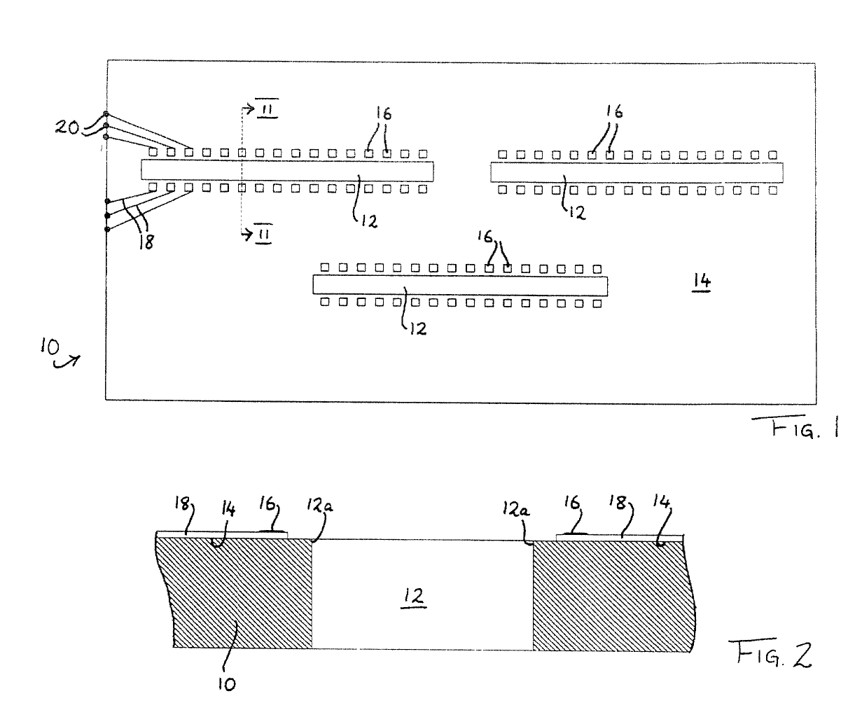

In FIG. 1 there is indicated, generally at 10, a portion of a silicon wafer for use as a substrate in an inkjet printhead according to a preferred embodiment of the invention. The substrate 10 has three ink supply slots 12 cut through the wafer from a rear surface (not shown) to a front surface 14. In a fully assembled print cartridge, each of these slots 12 will communicate with a passage leading to a reservoir containing a different coloured ink.

Located adjacent the periphery of each slot 12 is an array of thin film resistors 16 which are connected via conductive traces 18 to a series of contacts 20. Contacts 20 are used to connect the traces 18 via flex beams (not shown), with corresponding traces on a flexible printhead-carrying circuit member (not shown), which in turn is mounted on a print cartridge. The flexible printhead-carrying circuit member enables printer control circuitry located within the printer to selectively energise individual resistors under the control of software in known manner.

Only a few traces 18 are shown in FIG. 1. It will be understood that each resistor 16 will be provided with a trace leading to a contact 20, and generally also with a trace providing connection to a common earth. Such details are part of the state of the art and are familiar to the skilled person.

FIG. 2 shows a section of the substrate 10 in the vicinity of an ink supply slot 12 (the sizes of the various components are not to scale). It can be seen that adjacent the periphery 12a of the ink supply slot 12 on the front surface 14 of the substrate 10, is provided a resistor 16 connected to a conductive trace 18. Again, for simplicity, the details of the deposited thin film layers 16, 18 have been omitted for simplicity. In a typical embodiment, the thin film layers will include not just the resistors (which may be formed from e.g. TaAl) and the conductive traces (e.g. Au, Al or Cu) leading from the power supply to the resistor and from the resistor to earth, but also various layers providing thermal insulation (e.g. SiO₂), chemical protection from the ink and heat (e.g. SiC and Si₃N₄), and passivation with mechanical strength (e.g. Ta).

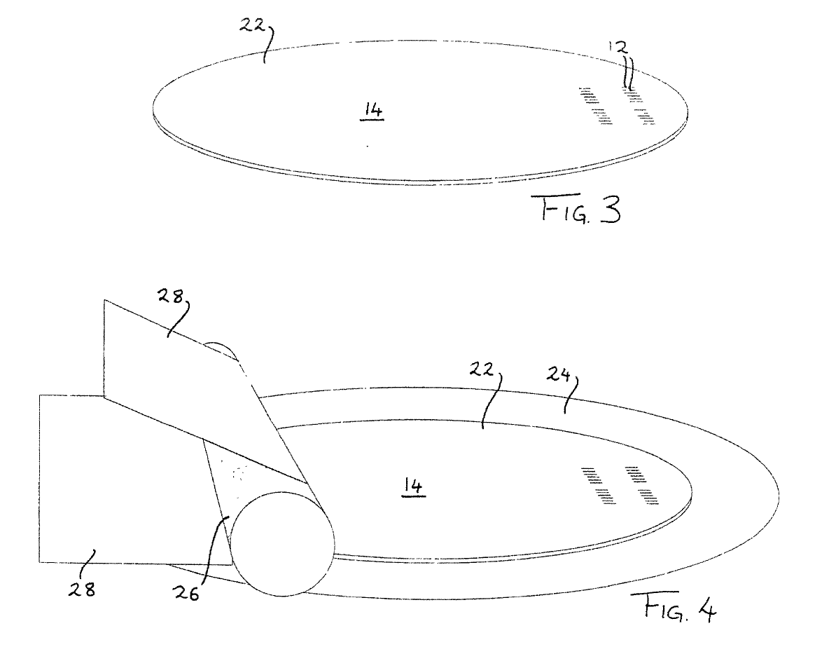

The substrate shown in FIG. 1 is cut from a large wafer crystal. While it is shown after cutting with the resistors exposed, in practice the further steps required to complete the printhead, as described below, will be carried out at the wafer level, and the individual printheads will be cut from the wafer after the printheads are substantially complete. Thus, FIG. 3 shows a large circular wafer crystal 22, in which a small number of the ink supply slots 12 (not to scale) are shown. In reality, the surface of the wafer will be covered with arrays of ink supply slots and the thin film circuitry described above. The ink supply slots 12 are created in the wafer using laser ablation, sand blasting or other wafer cutting techniques. The slots can be cut either before (preferably) or after the thin film circuitry is laid down.

In the next process step according to a preferred embodiment of the invention (FIG. 4), the wafer 22 is placed on a heated chuck 24 with the front surface 14 upwards. A pressure roller 26 then applies a conformal tape 28 across the wafer, covering the front surface. The conformal tape used may be polydimethylsiloxane (PDMS) tape which is a semi-rigid tape which will conform well to the contours of the front surface of the wafer and mildly adhere to the surface when heated.

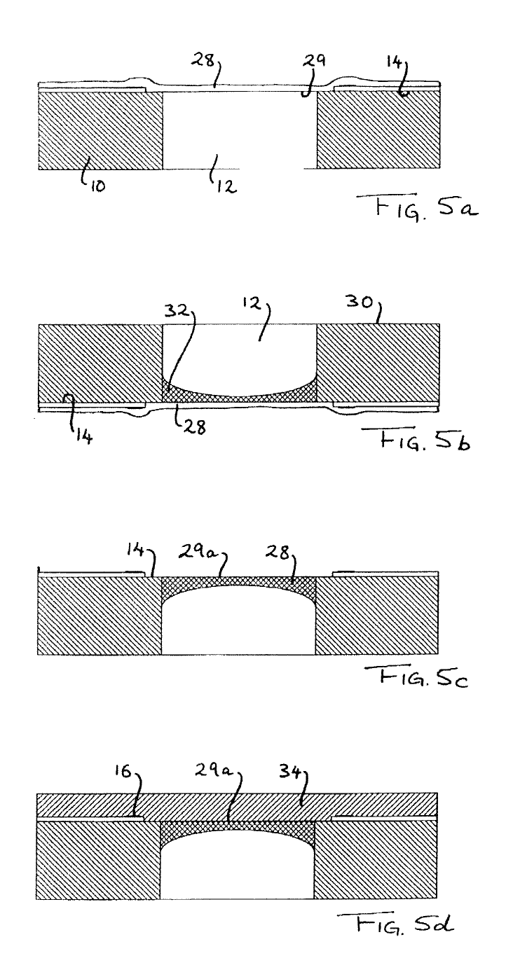

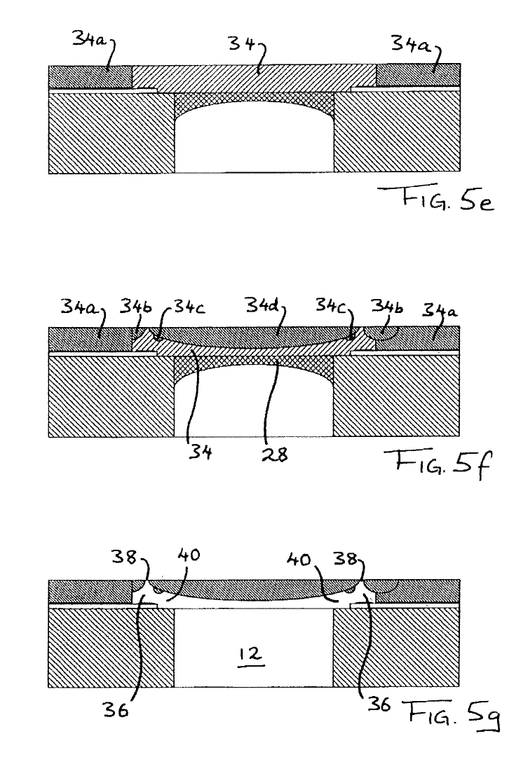

FIG. 5a shows the portion of substrate shown in FIG. 2 after the conformal tape 28 has been applied to the wafer. It can be seen that the tape conforms generally to the front surface 14 of the wafer and stretches across the mouth of the ink supply slot, thereby recreating the original surface of the substrate before the slot 12 was created with tape boundary surface 29.

In the next step (FIG. 5b), the wafer is inverted such that the rear surface 30 is uppermost. Each of the ink supply slots is then partially filled with a flowable filler material 32 which flows against the conformal tape 28. The filler material 32 is preferably a low melting point solid such as a wax or a saponified salt (e.g. sodium stearate), or it may be a low photosensitivity (dyed) SU-8 photoresist (available from MicroChem Corp., Newton, Mass.) which is softbaked, or a photoresist such as AZP4620.

The filler material can be dispensed using a tool such as the Asymtek Liquid Dispenser Millennium Series M-2010, or any other tool suitable to fill a liquid into a small orifice.

When the filler material has solidified, the conformal tape is removed (FIG. 5c) and the wafer is re-inverted, leaving a false surface 29a on the filler material 32 which is substantially co-planar with the front surface 14 of the substrate 10. The false surface 29a enables a photoresist layer to be spun across the surface of the wafer, without the ink supply slots interrupting the flow of the photoresist. FIG. 5d shows the wafer after an SU-8 photoresist layer 34 has been spun across the surface, covering the false surface 29a and the resistors 16.

The photoresist layer is then subjected to an intensive exposure step in which the lateral boundaries of the thermal ejection chambers surrounding each of the resistors is defined. As seen in FIG. 5e, the photoresist 34a exposed in this step (indicated as a darker hatching) is crosslinked through the depth of the photoresist layer 34. Each resistor will be isolated laterally within a chamber after this step, such that it is in communication only with the ink supply slot.

A second or a further series of less intensive exposures is then made (FIG. 5f) which crosslink the photoresist in a number of areas 34b, 34c, 34d, to differing depths, but not necessarily through the full depth of the photoresist layer 34. The boundaries between the exposed and unexposed regions of photoresist can thereby be made to define a 3-dimensional structure.

The unexposed photoresist and the filler material can be washed away using conventional development steps to reveal the interface between the crosslinked photoresist and the areas which had been filled with unexposed photoresist and filler material. This boundary defines (see FIG. 5g) thermal ejection chambers 36, orifices 38 (between areas 34b and 34c as seen in FIG. 5f) and ink supply passages 40 leading between the ink fill slot 12 and the thermal ejection chambers 36. The precise shape and configuration of the thermal ejection chambers, orifices and associated structures can be varied widely as required to achieve a given objective.

This not only obviates the need for a separate nozzle plate, but also reduces the length of path through which the ink needs to travel before ejection. Because it travels a shorter distance relative to the surfaces past which it must move, the ink is subject to less frictional drag and therefore fewer satellite drops are generated. This enables the printer to work at higher speeds.

In summary, therefore, by generating ink supply slots in a substrate and depositing thin film circuitry and resistors on a front surface of the substrate, before covering this front surface (including the opening for the ink supply slots) with a conformal tape, the ink supply slots can be back-filled with a filler material which hardens to generate a false surface coplanar with the front surface of the substrate. This false surface allows a thin photoresist layer to be spun across the front surface. The photoresist is selectively exposed to create structures defining both thermal ejection chambers bounding the resistors in a lateral direction and the upper surfaces of these chambers, including ink droplet ejection orifices, thereby obviating the need for a separate nozzle plate and reducing the thickness of the printhead. The method of the invention may also substantially reduce the number of processing steps involved in creating a finished printhead.

What is claimed is:

1. A method of fabricating an inkjet printhead comprising the steps of:
a) providing a substrate having opposed front and rear surfaces and at least one ink supply slot which extends completely through the substrate between the front and rear surfaces;
b) at least partially filling the ink supply slot with a filler material which terminates at a false surface in the ink slot substantially coplanar with the front surface of the substrate;
c) covering the front surface and the false surface with a layer of resist material;
d) exposing a pattern in the resist material to enable the selective removal of a portion of the resist material;
e) removing said portion of the resist material and thereby revealing a three-dimensional structure in the resist material; and
f) removing said filler material from said ink supply slot.

2. A method according to claim 1, wherein said structure includes a plurality of ink ejection chambers and a plurality of orifices leading from said ink ejection chambers.

3. A method according to claim 1, wherein step (a) comprises:
i) providing a substrate having opposed front and rear surfaces;
ii) forming a plurality of resistors and conductive traces on the front surface of the substrate; and
iii) creating an ink supply slot which extends completely through the substrate between the front and rear surfaces.

4. A method according to claim 1, wherein step (a) comprises:
i) providing a substrate having opposed front and rear surfaces;
ii) forming a plurality of piezoelectric ink ejection elements and conductive traces on the front surface of the substrate; and
iii) creating an ink supply slot which extends completely through the substrate between the front and rear surfaces.

5. A method according to claim 1, wherein step (b) comprises applying a conformal laminate to the front surface of the substrate, filling said filler material into the ink supply slot from the rear surface, and removing the conformal laminate, whereby the interface with the conformal laminate provides said false surface.

6. A method according to claim 5, wherein said step of applying a conformal laminate comprises heating said laminate and applying said laminate to the front surface with a roller.

7. A method according to claim 1, wherein said filler material is a flowable material which solidifies under predetermined conditions.

8. A method according to claim 7, wherein said filler material is a low-melting point solid.

9. A method according to claim 7, wherein said filler material is selected from a wax and a photoresist.

10. A method according to claim 1, wherein said resist material is a selected from a photoresist and an ion-imageable resist.

11. A method according to claim 10, wherein step (d) comprises subjecting the resist material in stages to different intensities and/or durations of exposure using different exposure patterns.

12. A method according to claim 11, wherein step (d) comprises a first exposure step effective to expose a first area of resist material through the entire depth of the resist material layer, and a second exposure step effective to expose a second area of resist material only partially into the depth of the resist material layer.

13. A method according to claim 12, wherein said first exposure step is used to define lateral boundaries of ink ejection chambers and wherein said second exposure step is used to define an upper surface of the ink ejection chambers and the boundaries of ink ejection orifices leading from said chambers.

14. A method according to claim 1, wherein said resist material is a positive resist and step (e) comprises chemically developing the substrate to wash away exposed resist material.

15. A method according to claim 1, wherein said resist material is a negative resist and step (e) comprises chemically developing the substrate to wash away unexposed resist material.

16. A method according to claim 14, wherein said step of chemically developing the substrate is further effective to remove the filler material in step (f).

17. An inkjet printhead comprising a substrate having opposed substantially parallel front and rear surfaces, at least one ink supply slot defined by substantially parallel sidewalls extending through said substrate between said front and rear surfaces, a plurality of ink ejection elements arrayed on the front surface of the substrate adjacent said ink supply slot, and a resist material layer covering said front surface and said ink ejection elements, wherein said resist material layer defines ink ejection chambers associated with said ink ejection elements, an ink supply path from said ink supply slot to said ink ejection elements, and integral ink ejection orifices associated with and leading from said thermal ejection chambers out of an exposed front surface of said resist material layer.

18. An inkjet printhead according to claim 17, when fabricated according to a method comprising the steps of:
a) providing a substrate having opposed front and rear surfaces and at least one ink supply slot which extends completely through the substrate between the front and rear surfaces;
b) at least partially filling the ink supply slot with a filler material which terminates at a false surface in the ink slot substantially coplanar with the front surface of the substrate;
c) covering the front surface and the false surface with a layer of resist material;
d) exposing a pattern in the resist material to enable the selective removal of a portion of the resist material;
e) removing said portion of the resist material and thereby revealing a three-dimensional structure in the resist material; and
f) removing said filler material from said ink supply slot.

19. A method of manufacturing a print cartridge comprising the steps of:
a) providing a cartridge body having at least one ink reservoir and at least one aperture for supplying ink from said reservoir to a printhead;
b) fabricating a printhead according to a method comprising the steps of:
i) providing a substrate having opposed front and rear surfaces and at least one ink supply slot which extends completely through the substrate between the front and rear surfaces;
ii) at least partially filling the ink supply slot with a filler material which terminates at a false surface in the ink slot substantially coplanar with the front surface of the substrate;
iii) covering the front surface and the false surface with a layer of resist material;
iv) exposing a pattern in the resist material to enable the selective removal of a portion of the resist material;
v) removing said portion of the resist material and thereby revealing a three-dimensional structure in the resist material; and
vi) removing said filler material from said ink supply slot; and
c) assembling said print head on said cartridge body with said at least one aperture in fluid communication with said at least one ink supply slot in the printhead.

20. A print cartridge comprising:
a) a cartridge body having at least one ink reservoir and at least one aperture for supplying ink from said reservoir to a printhead; and
b) a printhead provided on said cartridge body, said printhead comprising a substrate having opposed substantially parallel front and rear surfaces, at least one ink supply slot defined by substantially parallel sidewalls extending through said substrate between said front and rear surfaces, said at least one ink supply slot being in fluid communication with said at least one aperture of said cartridge body, a plurality of ink ejection elements arrayed on the front surface of the substrate adjacent said ink supply slot, and a resist material layer covering said front surface and said ink ejection elements, wherein said resist material layer defines ink ejection chambers associated with said ink ejection elements, an ink supply path from said ink supply slot to said ink ejection elements, and integral ink ejection orifices associated with and leading from said thermal ejection chambers out of an exposed front surface of said resist material layer.
